(19) United States
(12) Patent Application Publication
(10) Pub. No.: US 2024/0002577 A1
(43) Pub. Date: Jan. 4, 2024

(54) POLYURETHANES WITH REDUCED ALDEHYDE EMISSION

(71) Applicant: BASF SE, Ludwigshafen Am Rhein (DE)

(72) Inventors: Zeljko TOMOVIC, Kempen (DE); Christian KÖNIG, Ludwigshafen (DE)

(21) Appl. No.: 18/251,943

(22) PCT Filed: Nov. 22, 2021
(86) PCT No.: PCT/EP2021/082467

§ 371 Date: May 5, 2023

(30) Foreign Application Priority Data
Nov. 25, 2020 (EP) 20209817.4

(51) Int. Cl. C08G 18/20; C08G 18/12; C08G 18/76; C08G 18/48; C08G 18/32; C08G 18/66; C08J 9/04

(52) U.S. Cl. CPC C08G 18/2081; C08G 18/12; C08G 18/7692; C08G 18/7671; C08G 18/485; C08G 18/3281; C08G 18/6688; C08J 9/04; C08G 2110/005; C08G 2110/0058; C08G 2110/0066; C08J 2375/08

(57) ABSTRACT

Disclosed herein are processes for producing polyurethanes including mixing (a) polyisocyanate, (b) polymeric compounds having isocyanate-reactive groups, (c) optionally catalysts, (d) compounds of general formula W-Kw-NH—C(O)—CH2-Q and optionally (e) blowing agents, (f) chain extenders and/or crosslinking agents and (g) auxiliaries and/or additives to afford a reaction mixture and reacting the reaction mixture to afford the polyurethane. Further disclosed herein are a polyurethane producible by such a process and a method of using such a polyurethane in enclosed spaces.

The present invention relates to processes for producing polyurethanes comprising mixing (a) polyisocyanate, (b) polymeric compounds having isocyanate-reactive groups, (c) option ally catalysts, (d) compounds of general formula W-Kw-NH—C(O)—CH₂-Q and optionally (e) blowing agents, (f) chain extenders and/or crosslinking agents and (g) auxiliaries and/or additives to afford a reaction mixture and reacting the reaction mixture to afford the polyurethane, wherein W represents a cyclic amine which may be substituted and which is bonded to Kw via a nitrogen atom, Kw represents a linear or branched-chain hydrocarbon radical, N represents a nitrogen atom, C represents a carbon atom, O represents an oxygen atom and H represents a hydrogen atom and Q represents cyanide (CN) or an electronegative radical of general formula —C(O)—R² and R² represents a radical selected from the group consisting of —NH₂, —NH—R³—NR⁴R⁵, OR⁶ or R⁷, wherein R³, R⁴, R⁵, R⁶ and R⁷ are independently selected from the group consisting of aliphatic, araliphatic or aromatic hydrocarbons which may be substituted. The compound (d) employed is especially a compound of general formula W-Kw-NH—C(O)—CH₂—C(O)—NH-Kw-W, wherein -Kw- and —W are more preferably each identical. The present invention further relates to a polyurethane producible by a process according to the invention and to the use of such a polyurethane in enclosed spaces, for example in means of transport.

Polyurethanes have numerous applications, for example in the furniture industry as seat cushioning or as a binder for particle board, as an insulation material in the construction industry, as an insulation material, for example of pipes, hot water storage tanks or refrigerators, and as trim pieces, for example in automotive manufacture. Polyurethanes are often employed in particular in automobile manufacturing, for example in automobile exterior trim as spoilers, roof elements, suspension elements and in automobile interior trim as headliners, foam carpet backings, door trims, steering wheels, gear knobs and seat cushioning.

It is known that polyurethanes have a propensity for emitting organic substances which can cause unpleasant odors or, in the case of high concentrations, unwellness. Enclosed spaces, for example in the interior of buildings or vehicles, for example automobiles, are particularly affected. One example of such emissions is the emission of aldehydes. Different approaches for reducing aldehyde emissions are already in existence.

Thus for example EP 1428847 describes that aldehyde emissions may be reduced by subsequent addition of polymeric substances having primary and/or secondary amino groups. The amine groups in the polymer are responsible for the reduction in emissions. Since these are isocyanate-reactive and are very largely deactivated by reaction with the isocyanate the polymeric active substance should be applied to the previously produced foam. Disadvantageous here is a cumbersome process comprising an additional step of aftertreatment of the foam. Use in compact systems or closed-cell foams is not possible.

US 20130203880 describes the use of polyhydrazodicarbonamide as a substance for reducing aldehyde emissions in polyurethane foams. However, a marked reduction in aldehydes is only achieved upon addition of a large amount of polyhydrazodicarbonamide of 2% to 5.5% by weight in the polyol component. Since polyhydrazodicarbonamide likewise has catalytic properties the addition of this substance on this scale alters the reaction profile. Further more, the aldehyde reduction achieved is in need of improvement even when large amounts of polyhydrazodicarbonamide are employed.

WO 2015082316 describes the use of CH-acidic compounds of general formula R¹—CH₂—R², wherein R¹ and R² independently of one another represent an electron withdrawing radical, for reducing formaldehyde emissions in combination with incorporable catalysts. This can efficiently reduce formaldehyde but the foam specimens still exhibit high emissions of volatile organic substances (VOC).

Aminocrotonic acid esters which can be used as catalysts in the production of polyurethanes are also known from EP629607. WO2016020200 describes polyurethane catalysts based on tertiary amines which have a pyrrolidine structure. WO2016020200 further discloses that the catalysts described are low-emission with regard to aldehyde emissions, especially with regard to formaldehyde emissions.

It is accordingly an object of the present invention to provide polyurethanes, in particular polyurethane foams, which have improved emission characteristics, in particular of aldehydes, such as formaldehyde, and which also have exceptional emission characteristics of further compounds, such as nitrogen-containing emissions and odor emissions.

The object of the invention is solved by a polyurethane producible by a process comprising mixing (a) polyisocyanate, (b) polymeric compounds having isocyanate-reactive groups, (c) optionally catalysts, (d) compounds of general formula W-Kw-NH—C(O)—CH₂-Q and option ally (e) blowing agents, (f) chain extenders and/or crosslinking agents and (g) auxiliaries and/or additives to afford a reaction mixture and reacting the reaction mixture to afford the polyurethane, wherein W represents a cyclic amine which may be substituted and which is bonded to Kw via a nitrogen atom, Kw represents a linear or branched-chain hydrocarbon radical, N represents a nitrogen atom, C represents a carbon atom, O represents an oxygen atom and H represents a hydrogen atom and Q represents cyanide (CN) or an electronegative radical of general formula —C(O)—R² and R² represents a radical selected from the group consisting of —NH₂, —NH—R³—NR⁴R⁵, OR⁶ or R⁷, wherein R³, R⁴, R⁵, R⁶ and R⁷ are independently selected from the group consisting of aliphatic, araliphatic or aromatic hydrocarbons which may be substituted.

The present invention further relates to the use of such polyurethanes in enclosed spaces, for example in means of transport.

For the purposes of the invention, the term “polyurethane” encompasses all known polyisocyanate polyaddition products. These encompass addition products derived from isocyanate and alcohol, and also encompass modified polyurethanes, which can comprise isocyanaurate structures, allophanate structures, urea structures, carbodiimide structures, uretonimine structures, biuret structures, and other isocyanate addition products. These polyurethanes according to the invention comprise in particular solid polyisocyanate polyaddition products, such as duromers, and foams based on polyisocyanate-polyaddition products, such as flexible foams, semi-rigid foams, rigid foams or integral foams and also polyurethane coatings and binders. “Polyurethanes” are further to be understood as meaning polymer blends comprising polyurethanes and further polymers, and also foams made of these polymer blends. The polyurethanes according to the invention are preferably polyurethane foams or solid polyurethanes which comprise no further polymers in addition to the polyurethane units (a) to (g) elucidated hereinbelow.

In the context of the invention “polyurethane foams” are to be understood as meaning foams according to DIN 7726. Flexible polyurethane foams according to the invention have a compressive stress at 10% compression/compressive strength according to DIN 53 421/DIN EN ISO 604 of 15 kPa or less, preferably 1 to 14 kPa and in particular 4 to 14 kPa. Semi-rigid polyurethane foams according to the invention have a compressive stress at 10% compression according to DIN 53 421/DIN EN ISO 604 of more than 15 to less than 80 kPa. According to DIN ISO 4590 semi-rigid polyurethane foams and flexible polyurethane foams according to the invention have an open-cell content of preferably more than 85%, particularly preferably more than 90%. Further details about flexible polyurethane foams and semi-rigid polyurethane foams according to the invention may be found in “Kunststoffhandbuch”, volume 7, “Polyurethane”, Carl Hanser Verlag, 3rd edition 1993, chapter 5.

The rigid polyurethane foams according to the invention exhibit a compressive stress at 10% compression of not less than 80 kPa, preferably not less than 120 kPa, particularly preferably not less than 150 kPa. Furthermore, the rigid polyurethane foam has a closed-cell content of more than 80%, preferably more than 90%, according to DIN ISO 4590. Further de tails about rigid polyurethane foams according to the invention may be found in “Kunststoffhandbuch”, volume 7, “Polyurethane”, Carl Hanser Verlag, 3rd edition 1993, chapter 6.

In the context of the present invention “elastomeric polyurethane foams” is to be under stood as meaning polyurethane foams according to DIN 7726 which after brief deformation by 50% of their thickness according to DIN 53 577 show no lasting deformation above 2% of their starting thickness after 10 minutes. A rigid polyurethane foam, a semi-rigid polyurethane foam or a flexible polyurethane foam may be concerned.

“Integral polyurethane foams” is to be understood as meaning polyurethane foams according to DIN 7726 having an edge zone that has a higher density than the core as a consequence of the molding process. The overall apparent density averaged over the core and the edge zone is preferably more than 100 g/L. In the context of the present invention integral polyurethane foams may also be rigid polyurethane foams, semi-rigid polyurethane foams or flexible polyurethane foams. Further details about integral polyurethane foams according to the invention may be found in “Kunststoffhandbuch”, volume 7, “Polyurethane”, Carl Hanser Verlag, 3rd edition 1993, chapter 7.

In a preferred embodiment the polyurethane according to the invention is a polyurethane foam having an average density of 10 to 850 g/L, preferably a semi-rigid polyurethane foam or a flexible polyurethane foam or a rigid polyurethane foam, particularly preferably an elastomeric flexible polyurethane foam, a semi-rigid polyurethane foam or an elastomeric integral polyurethane foam. The elastomeric integral polyurethane foam preferably has a density averaged over the core and the edge zone of 150 g/L to 500 g/L. The flexible polyurethane foam preferably has an average density of 10 to 100 g/L. The semi-rigid polyurethane foam preferably has an average density of 70 to 150 g/L. In the context of the present invention the average density of the polyurethane foams is to be understood as meaning the density of the foam averaged over the polyurethane proportion, for example in the cell walls and lamellae of the foam, and the gas comprised by the polyurethane foam body.

In another preferred embodiment, the polyurethane is a solid polyurethane with density preferably above 850 g/L, preferably 900 to 1400 g/L and particularly preferably 1000 to 1300 g/L. A solid polyurethane is obtained here, without addition of any blowing agent. For the purposes of the present invention, small quantities of blowing agent, for example water present in the polyols as a result of the production process, are not interpreted here as constituting addition of blowing agent. The reaction mixture for the production of the compact polyurethane preferably comprises less than 0.2% by weight, with particular preference less than 0.1% by weight and in particular less than 0.05% by weight, of water.

The polyurethane according to the invention is preferably employed in the interior of means of transport, such as ships, airplanes, lorries, passenger cars or buses, especially passenger cars or buses and especially cars. The interior of passenger cars and buses is hereinbelow referred to as an automotive interior part. A flexible polyurethane foam can be used as a seat cushion, a semi-rigid polyurethane foam as back-foaming for door trim elements or instrument panels, an integral polyurethane foam as a steering wheel, shift knob or headrest and a solid polyurethane as a cable sheathing for example.

The polyisocyanate components (a) used for producing the polyurethanes according to the invention comprise all polyisocyanates known for the production of polyurethanes. These comprise the aliphatic, cycloaliphatic and aromatic divalent or polyvalent isocyanates known from the prior art and any desired mixtures thereof. Examples are diphenylmethane 2,2′-, 2,4′- and 4,4′-diisocyanate, the mixtures of monomeric diphenylmethane diisocyanates with diphenylmethane diisocyanate homologs having a larger number of rings (polymer MDI), isophorone diisocyanate (IPDI) and its oligomers, tolylene 2,4- or 2,6-diisocyanate (TDI) and mixtures of these, tetramethylene diisocyanate and its oligomers, hexamethylene diisocyanate (HDI) and its oligomers, naphthylene diisocyanate (NDI) and mixtures thereof.

Preference is given to 2,4- and/or 2,6-tolylene diisocyanate (TDI) or mixtures thereof, monomeric diphenylmethane diisocyanates and/or higher nuclear homologs of diphenylmethane diisocyanate (polymeric MDI) and mixtures thereof. Further possible isocyanates are recited for example in “Kunststoffhandbuch”, volume 7, “Polyurethane”, Carl Hanser Verlag, 3rd edition 1993, chapters 3.2 and 3.3.2.

The polyisocyanate component (a) may be employed in the form of polyisocyanate prepolymers. These polyisocyanate prepolymers are obtainable by reacting an excess of the abovementioned polyisocyanates (constituent (a-1)) with polymeric compounds having isocyanate-reactive groups (b) (constituent (a-2)) and/or chain extenders (f) (constituent (a-3)) for example at temperatures of 30° C. to 100° C., preferably at about 80° C., to afford the isocyanate prepolymer.

Polymeric compounds having isocyanate-reactive groups (a-2) and chain extenders (a3) are known to those skilled in the art and described for example in “Kunststoffhandbuch [Plastics Handbook], volume 7, Polyurethane [Polyurethanes]”, Carl Hanser Verlag, 3rd edition 1993, chapter 3.1. Thus also employable as polymeric compounds having isocyanate-reactive groups (a-2) are the polymeric compounds having isocyanate-reactive groups described below under (b).

Employable polymeric compounds having isocyanate-reactive groups (b) include all known compounds having at least two isocyanate-reactive hydrogen atoms, for example those having a functionality of 2 to 8 and a number-average molecular weight of 400 to 15 000 g/mol. It is thus possible to use for example compounds selected from the group comprising polyether polyols, polyester polyols and mixtures thereof.

Polyetherols are produced for example from epoxides, such as propylene oxide and/or eth ylene oxide, or from tetrahydrofuran with hydrogen-active starter compounds, such as aliphatic alcohols, phenols, amines, carboxylic acids, water and compounds based on natural substances, such as sucrose, sorbitol or mannitol, using a catalyst. These may include basic catalysts or double-metal cyanide catalysts, as described for example in PCT/EP2005/010124, EP 90444 or WO 05/090440.

Polyesterols are by way of example produced from aliphatic or aromatic dicarboxylic acids and polyhydric alcohols, polythioether polyols, polyesteramides, hydroxylated polyacetals and/or hydroxylated aliphatic polycarbonates, preferably in the presence of an esterification catalyst. Further possible polyols are recited, for example, in “Kunststoffhandbuch, Band 7, Polyurethane”, Carl Hanser Verlag, 3rd Edition, 1993, Chapter 3.1.

Also employable in addition to the described polyetherols and polyesterols are filler-containing polyetherols and polyesterols, also known as polymer polyetherols or polymer polyesterols. Such compounds preferably comprise dispersed particles of thermoplastics, for ex ample constructed from olefinic monomers, such as acrylonitrile, styrene, methacrylates, methacrylic acid and/or acrylamide. Such filler-containing polyols are known and commercially available. Their production is described, for example, in DE 111 394, U.S. Pat. Nos. 3,304,273, 3,383,351, 3,523,093, DE 1 152 536, DE 1 152 537 WO 2008/055952 and WO2009/128279. It is further possible to employ as the polymeric compounds according to the invention having isocyanate-reactive groups (b) at least one polyesterol obtainable by polycondensation of an acid component with an alcohol component, wherein the acid component is malonic acid and/or derivatives thereof and the alcohol component is an aliphatic dialcohol having 4 to 12 carbon atoms. The production thereof is described for example in WO 2019/149583.

In a particularly preferred embodiment of the present invention the component (b) comprises polyetherols and more preferably no polyesterols.

The catalytic effect of the compounds of general formula W-Kw-NH—C(O)—CH₂-Q (d) makes it possible to reduce the use of further polyurethane catalysts. If further catalysts (c) are employed all customary polyurethane catalysts may be used. If employed, the catalysts (c) preferably comprise incorporable amine catalysts, particularly preferably consist of incorporable amine catalysts. Catalysts (c) do not comprise any compounds already included under the definition of compounds of general formula W-Kw-NH—C(O)—CH₂-Q (d).

Typical catalysts employable for production of include for example amidines, such as 2,3-dimethyl-3,4,5,6-tetrahydropyrimidine, tertiary amines, such as triethylamine, tributylamine, dimethylbenzylamine, N-methyl-, N-ethyl- and N-cyclohexylmorpholine, N,N,N′,N′-tetramethylethylenediamine, N,N,N′,N′-tetramethylbutanediamine, N,N,N′,N′-tetramethylhexanediamine, pentamethyldiethylenetriamine, tetramethyldiaminoethyl ether, bis(dimethylaminopropyl)urea, dimethylpiperazine, 1,2-dimethylimidazole, 1-azabicyclo[3.3.0]octane and preferably 1,4-diazabicyclo[2.2.2]octane, and alkanolamine compounds such as triethanolamine, triisopropanolamine, N-methyl- and N-ethyldiethanolamine and dimethylethanolamine. It is also possible to use organic metal compounds, preferably organic tin compounds, for example tin(II) salts of organic carboxylic acids, e.g. tin(II) acetate, tin(II) octoate, tin(II) ethylhexoate and tin(II) laurate, and the dialkyltin(IV) salts of organic carboxylic acids, e.g. dibutyltin diacetate, dibutyltin dilaurate, dibutyltin maleate and dioctyltin diacetate, and also bismuth carboxylates, such as bismuth(III) neodecanoate, bismuth 2-ethylhexanoate and bismuth octanoate, or mixtures thereof. The organometallic compounds can be used alone or preferably in combination with strongly basic amines. If component (b) is an ester it is preferable to use exclusively amine catalysts.

Incorporable amine catalysts have at least one, preferably 1 to 8 and particularly preferably 1 to 2 isocyanate-reactive groups, such as primary amine groups, secondary amine groups, hydroxyl groups, amides or urea groups, preferably primary amine groups, secondary amine groups, hydroxyl groups. Incorporable amine catalysts are mostly used for the production of low-emission polyurethanes which are especially used in automotive interiors. Such catalysts are known and described for example in EP1888664. These comprise compounds which, in addition to the isocyanate-reactive group(s), preferably comprise one or more tertiary amino groups. It is preferable when at least one of the tertiary amino groups of the incorporable catalysts bears at least two aliphatic hydrocarbon radicals, preferably having 1 to 10 carbon atoms per radical, more preferably having 1 to 6 carbon atoms per radical. It is particularly preferable when the tertiary amino groups bear two radicals independently of one another selected from methyl and ethyl and also a further organic radical. Examples of incorporable catalysts that may be used are bis(dimethylaminopropyl)urea, bis(N,N-dimethylaminoethoxyethyl) carbamate, dimethylaminopropylurea, N,N,N-trimethyl-N-hydroxyethylbis(aminopropylether), N,N,N-trimethyl-N-hydroxyethylbis(aminoethylether), diethylethanolamine, bis(N,N-dimethyl-3-aminopropyl)amine, 1-(3-aminopropyl)pyrrolidine, dimethylaminopropylamine, 3-dimethylaminopropyl-N,N-dimethylpropane-1,3-diamine, dimethyl-2-(2-aminoethoxyethanol), (1,3-bis(dimethylamino)propan-2-ol), N,N-bis(3-dimethylaminopropyl)-N-isopropanolamine, bis(dimethylaminopropyl)-2-hydroxyethylamine, N,N,N-trimethyl-N-(3-aminopropyl)-bis(aminoethylether), 1,4-diazabicyclo[2.2.2]octane-2-methanol and 3-dimethylaminoisopropyl diisopropanolamine or mixtures thereof.

When catalysts (c) are employed these may be employed for example in a concentration of 0.001% to 5% by weight, in particular 0.05% to 2% by weight, as a catalyst/catalyst combination based on the total weight of the component (b).

Such compounds are employed as compounds of formula W-Kw-NH—C(O)—CH₂-Q (d). W represents a cyclic amine which may be substituted and which is bonded to -Kw- via a nitrogen atom. W— preferably represents a pyrrolidine radical which is bonded to -Kw- via the nitrogen atom. The hydrogen atoms of the pyrrolidine radical may be substituted but prefer ably the pyrrolidine radical is unsubstituted. -Kw- preferably represents a linear or branched-chain, preferably linear, hydrocarbon radical having preferably 1 to 20, particularly preferably 1 to 10, more preferably 2 to 5, and in particular 3 carbon atoms. N, C, O and H in the formula represent atoms of the chemical elements nitrogen (N), carbon (C), oxygen (O) and hydrogen (H). Q represents cyanide (CN) or an electron-withdrawing radical of general formula —C(O)—R², wherein R² is a radical selected from the group consisting of —NH₂, —NH—R³—NR⁴R⁵, OR⁶ or R⁷, wherein R³, R⁴, R⁵, R⁶ and R⁷ are independently selected from the group consisting of aliphatic, araliphatic or aromatic hydrocarbons which may be substituted. In a preferred embodiment, R² represents —CH₃, —OCH₃, —C₂H₅, —OC₂H₅, —C₃H₇, —OC₃H₇, —CₗH₂ₗ₊₁, —O—CₗH₂ₗ₊₁, —O—CₗH₂ₗOH, —O—(C₂H₄O)ₘH, —O—(C₃H₆O)ₘH, —O—(C₄H₈O)ₘH, —NHCH₃, —NH—CₗH₂ₗ₊₁, —NH—(C₂H₄O)ₘH, —NH—(C₃H₆O)ₘH, —NH—CₗH₂ₗ—NH₂, —NH—CₗH₂ₗ—OH, —NH—(C₂H₄O)ₘ—C₂H₄NH₂, —NH—(C₃H₆O)ₘ—C₃H₆NH₂, —NH—(C₄H₈O)ₘ—C₄H₈NH₂, —NH—NH—CₗH₂ₗ₊₁, —NH—NH—CₗH₂ₗOH, —NH—NH—CₗH₂ₗNH₂, —NH—NH—(C₂H₄O)ₘH, —NH—NH—(C₂H₄O)ₘ—C₂H₄NH₂, —NH—NH—(C₃H₆O)ₘH, —NH—NH—(C₃H₆O)ₘ—C₃H₆NH₂, —NH₂, wherein l represents integers from 1 to 20, preferably 1 to 10, and m represents integers from 1 to 50, preferably from 1 to 25 and particularly preferably —NH—NH₂ or —NH-Kw-W, wherein -Kw- and —W are as described above, R² in this case represents NH—R³ and R³ represents the substituted, aliphatic hydro carbon Kw-W. The compound (d) employed is in particular a compound of general formula W-Kw-NH—C(O)—CH₂—C(O)—NH-Kw-W, wherein -Kw- and —W are more preferably each identical.

Particularly preferred compounds (d) are:

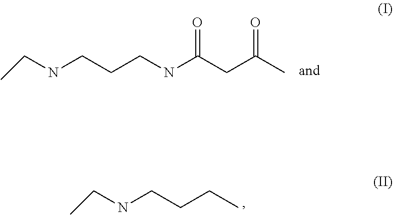

in particular the compound of formula (I).

The compound (d) is preferably employed in an amount of 0.001% to 5% by weight, in particular 0.05% to 2% by weight, based on the weight of the component (b).

When the polyurethane according to the invention is to be in the form of a polyurethane foam reaction mixtures according to the invention further comprise blowing agent (e). Any blowing agents known for the production of polyurethanes may be employed. These may comprise chemical and/or physical blowing agents. Such blowing agents are described for example in “Kunststoffhandbuch”, volume 7, “Polyurethane”, Carl Hanser Verlag, 3rd edition 1993, chapter 3.4.5. “Chemical blowing agents” is to be understood as meaning compounds that form gaseous products by reaction with isocyanate. Examples of such blowing agents are water or carboxylic acids. “Physical blowing agents” is to be understood as meaning compounds that are dissolved or emulsified in the input materials of polyurethane production and vaporize under the conditions of polyurethane formation. Examples thereof include hydrocarbons, halogenated hydrocarbons and other compounds, for example perfluorinated alkanes, such as perfluorohexane, chlorofluorohydrocarbons, and ethers, esters, ketones, acetals and/or liquid carbon dioxide. The blowing agent may be employed in any desired amount. The blowing agent is preferably employed in an amount such that the resulting polyurethane foam has a density of 10 to 850 g/L, particularly preferably 20 to 800 g/L and in particular 25 to 500 g/L. It is particularly preferable to employ blowing agents comprising water.

Employable chain extenders and crosslinking agents (f) include compounds compounds having at least two isocyanate-reactive groups and a molecular weight of less than 400 g/mol, wherein molecules having two isocyanate-reactive hydrogen atoms are referred to as chain extenders and molecules having more than two isocyanate-reactive hydrogens are referred to as crosslinking agents. However, it is also possible to dispense with the chain ex tenders or crosslinking agents. However, addition of chain extenders, crosslinking agents, or optionally also mixtures thereof, can prove to be advantageous for modifying mechanical properties, for example hardness.

When chain extenders and/or crosslinking agents are to be employed these are typically employed in amounts of 0.5% to 60% by weight, preferably 1% to 40% by weight and particularly preferably 1.5% to 20% by weight in each case based on the total weight of the components (b) to (f).

When chain extenders and/or crosslinking agents (f) are employed the chain extenders and/or crosslinking agents familiar in the production of polyurethanes may be used. These are preferably low molecular weight compounds having isocyanate-reactive functional groups, for example glycerol, trimethylolpropane, glycol and diamines. Further possible low molecular weight chain extenders and/or crosslinking agents are recited, for example, in “Kunststoffhandbuch”, volume 7, “Polyurethane”, Carl Hanser Verlag, 3rd edition 1993, chapters 3.2 and 3.3.2.

Auxiliaries and/or additives (g) may also be employed. All of the auxiliary and additive sub stances known for producing polyurethanes may be employed here. Examples include surface-active substances, foam stabilizers, cell regulators, release agents, fillers, dyes, pigments, flame retardants, antioxidants, hydrolysis stabilizers, fungistatic and bacteriostatic substances. Such substances are known and are described for example in “Kunststoffhandbuch, Band 7, Polyurethane”, Carl Hanser Verlag, 3rd edition 1993, chapters 3.4.4 and 3.4.6 to 3.4.11.

Especially the combination of compounds (d) and antioxidants leads to a further reduced emission of organic substances, such as aldehydes. Examples of antioxidants are phenolic substances, such as 2,6-di-tert-butyl-4-methylphenol, benzenepropanolic acid, 3,5-bis(1,1-dimethylethyl)-4-hydroxy-C7-C9 branched alkyl esters, aminic antioxidants such as N,N′-diisopropyl-p-phenylenediamine, thiosynergists, such as dilauryl 5-thiodipropionate, phosphites and phosphonites, such as triphenylphosphites, diphenylalkylphosphites, benzofuranones and indolinones, other antioxidants such as O-, N- and S-benzyl compounds, triazine compounds, amides of β-(3,5-di-tert-butyl-4-hydroxyphenyl)propionic acid, esters of substituted and unsubstituted benzoic acids, nickel compounds and esters of β10-thiodipropionic acid or a mixture of two or more of these antioxidants. Such antioxidants are de scribed, for example, in WO2017125291 and are commercially available for example under the trade names Irganox 1076, Irganox 245, Irganox 2000, Irganox E201 (vitamin E), Irganox 5057 or Irgafos 38.

In general the production of the polyurethane according to the invention comprises reacting the polyisocyanates (a), the polyols (b), catalysts (c), compounds (d) and, where employed, the blowing agents (e) and chain extenders (f) and/or crosslinking agents (g) in amounts such that the equivalence ratio of NCO groups of the polyisocyanates (a) to the sum of the reactive hydrogen atoms of the components (b), (c), (d) and optionally (e), (f) and (g) is 0.75 to 1.5:1, preferably 0.80 to 1.25:1. If the cellular plastics at least partially comprise isocyanurate groups, a ratio of NCO groups of the polyisocyanates (a) to the sum of the reactive hydrogen atoms of the components (b), (c), (d) and optionally (e), (f) and (g) of 1.5 to 20:1, preferably 1.5 to 8:1, is typically used. A ratio of 1:1 corresponds to an isocyanate index of 100.

The specific starting substances (a) to (g) for producing polyurethanes according to the invention in each case differ quantitatively and qualitatively only to a small extent when the inventive polyurethane to be produced is a thermoplastic polyurethane, a flexible foam, a semi-rigid foam, a rigid foam or an integral foam. Thus, for example, the production of solid polyurethanes employs no blowing agents and the production of thermoplastic polyurethane employs predominantly strictly difunctional starting substances. It is moreover possible by way of example to vary the elasticity and hardness of the polyurethane of the invention by way of the functionality and the chain length of the higher-molecular-weight compound having at least two reactive hydrogen atoms. Such modifications are known to the person skilled in the art.

The reactants for producing a solid polyurethane are described for example in EP 0989146 or EP 1460094, the reactants for producing a flexible foam for example in PCT/EP2005/010124 and EP 1529792, the reactants for producing a semi-rigid foam for example in “Kunststoffhandbuch, Band 7, Polyurethane”, Carl Hanser Verlag, 3rd edition 1993, chapter 5.4, the reactants for producing a rigid foam in PCT/EP2005/010955 and the reactants for producing an integral foam for example in EP 364854, U.S. Pat. No. 5,506,275 or EP 897402. The compounds (d) are then added to the reactants described in these documents in each case.

The invention provides not only the process of the invention but also a polyurethane obtain able by a process of the invention. The polyurethanes according to the invention are preferably used in enclosed spaces, for example as thermal insulation materials in residential buildings, such as insulation for pipes and refrigerators, in furniture construction, for example as decorative elements or as seat cushions, as mattresses and in the interior of vehicles, for example in automobile interiors, for example as steering wheels, dashboards, door trims, carpet foam backings, acoustic foams, such as headliners, and also headrests or gear knobs. For polyurethanes according to the invention especially the formaldehyde emissions are markedly reduced not only compared to a reference product without an additive but also compared to prior art additives for aldehyde reaction. Polyurethanes according to the invention further emit only very small amounts of volatile organic compounds (VOC) according to VDA 278 and VDA 277. Finally, the polyurethanes according to the invention show exceptional aging behavior and heat resistance.

The invention will be illustrated below with reference to examples.

### Production of the Inventive Compound A1:

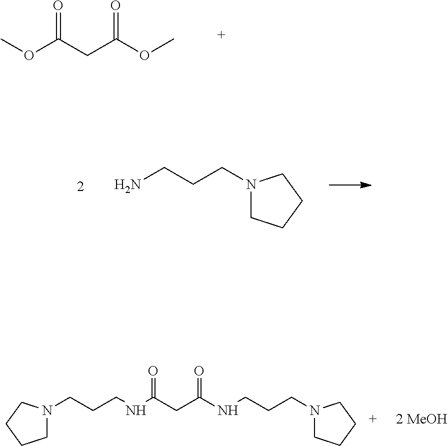

12.6 g of dimethyl malonate and 25.1 g of N-(aminopropyl)pyrrolidine were heated in a glass flask at 150° C. for 6 h. A vacuum was then carefully applied at this temperature and volatile compounds (starting materials (N-(aminopropyl)pyrrolidine boils at 82° C. and 27 mbar) and the methanol formed) were distilled off at 10 mbar over 1 h. A clear red liquid was obtained. Complete conversion of the dimethyl malonate was confirmed by NMR spectroscopy. After cooling to room temperature the product was used without further purification.

### Production of Comparative Substance V1:

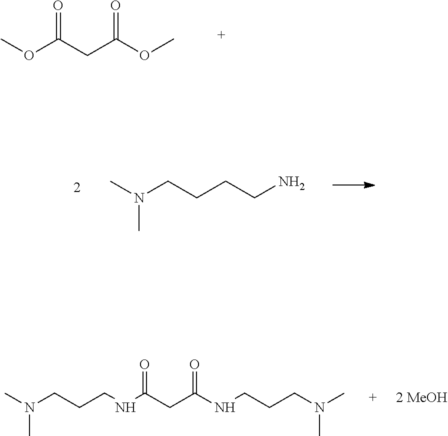

48.49 g of dimethyl malonate and 93.75 g of 3-(dimethylamino)-1-propylamine were heated in a glass flask at 120° C. for 6 h. A vacuum was then carefully applied at this temperature and volatile compounds were distilled off at 12 mbar over 1 h. A clear orange liquid was obtained. Complete conversion of the dimethyl malonate was confirmed by NMR spectroscopy. After cooling to room temperature the product was used without further purification.

The polyurethane materials were produced as follows:

### Starting Materials:

Polyol 1: Glycerol-started polyether polyol based on ethylene oxide and propylene oxide having an average OH number of 27 mg KOH/g, an average functionality of 2.5 and a propylene oxide content based on the total weight of the polyether of 78% by weight.
Polyol 2: Glycerol-started polyether polyol based on ethylene oxide and propylene oxide having an average OH number of 35 mg KOH/g, an average functionality of 2.7 and a propylene oxide content based on the total weight of the polyether of 85% by weight.
Polyol 3: Glycerol-started polyether polyol based on ethylene oxide and propylene oxide having an average OH number of 42 mg KOH/g, an average functionality of 2.7 and a propylene oxide content based on the total weight of the polyether of 25% by weight.
Polyol 4: Polyester polyol composed of adipic acid, 1,4-butanediol, isophthalic acid and monoethylene glycol having an average OH number of 55 mg KOH/g.
TEOA: Triethanolamine
Isopur SU-12021: Black color paste from ISL-Chemie
Emulsifier: Half-ester of a maleic acid-olefin copolymer
Jeffcat® ZF10: Catalyst from Huntsman
Iso 1: Polymeric diphenylmethane diisocyanate (PMDI) having an NCO content of 31.5% by weight and an average functionality of 2.7.
Iso 2: Prepolymer of methylenediphenyl diisocyanate, dipropylene glycol and polyether polyol having an average OH number of 250 mg KOH/g, a functionality of 2, a propylene oxide content based on the total weight of the polyether of 83% by weight, an NCO content of 23% by weight and an average functionality of 2.
Iso 3: Mixture of methylenediphenyl diisocyanate and the corresponding carbodiimide having an NCO content of 29.5% by weight and an average functionality of 2.2.

The following compounds (d) were employed:

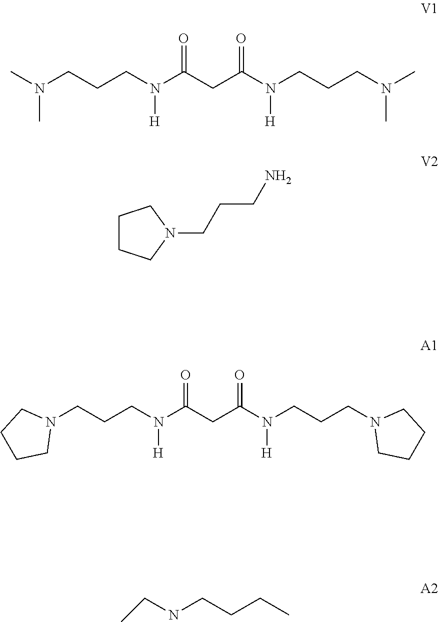

Mixture A was produced by mixing the following components:
50.0 parts by weight of polyol 1
34.3 parts by weight of polyol 2
2.0 parts by weight of polyol 3
6.0 parts by weight of polyol 4
0.5 parts by weight of TEOA
0.5 parts by weight of emulsifier
0.5 parts by weight of Isopur SU-12021
2.9 parts by weight of water
0.3 parts by weight of Jeffcat ZF10
0.5-0.8 parts by weight of compounds V1, V2, A1 or A2 (in each case equimolar amounts, based on the catalytically active tertiary nitrogen)

The isocyanate component was produced by mixing the following components:
30.0 parts by weight of iso 1
35.0 parts by weight of iso 2
35.0 parts by weight of iso 3

The mixture A, comprising the compounds V1, V2, A1 or A2, and the isocyanate component were mixed with one another at an Isocyanate index of 100 and added to a closed mold to afford moldings having an average density of 120 g/L.

Formaldehyde and acetaldehyde was determined by a procedure analogous to ASTM D-5116-06. The chamber size was 4.7 liters. The polyurethane samples used were pieces of 110 mm×100 mm×25 mm in size from the interior of the foam. The temperature in the measuring chamber during the measurement was 65° C., the relative humidity 50%. The air change rate was 3.0 liters per hour. The exhaust air stream comprising volatile aldehydes from the polyurethane was passed through a cartridge comprising silica coated with 2,4-dinitrophenylhydrazine over 120 minutes. The DNPH cartridge was then eluted with a mixture of acetonitrile and water. The concentration of formaldehyde and acetaldehyde in the eluate was determined by HPLC. With this setup the limit of detection for formaldehyde emissions is ≤11 μg/m³ and for acetaldehyde emissions is ≤6 μg/m³.

Table 1: Chamber-determined formaldehyde values of semi-rigid foams upon addition of the respective additives V1-V2 and A1-A2 in the specified concentrations, in each case re ported in parts by weight of the abovementioned mixture A.

TABLE 1

| | V1 | V2 | A1 | A2 |
|---|---|---|---|---|
| Pts. by wt. | 0.53 | 0.5 | 0.63 | 0.76 |
| Cream time (s) | 9 | 10 | 10 | 9 |
| Rise time (s) | 64 | 73 | 76 | 79 |
| FRD (g/l) | 51.2 | 55.2 | 53.6 | 54.6 |
| Formaldehyde | 114 | 143 | 58 | 71 |
| (μg/m3) | | | | |
| Acetaldehyde | 171 | 169 | 169 | 175 |
| (μg/m3) | | | | |

Table 1 shows that the use of inventive component (d) in mixture A in each case reduces the formaldehyde emissions very markedly compared with comparative compounds V1 and V2.

1. A process for producing polyurethanes comprising mixing:
(a) polyisocyanate,
(b) polymeric compounds having isocyanate-reactive groups,
(c) optionally catalysts,
(d) compounds of general formula W-Kw-NH—C(O)—CH₂-Q and optionally
(e) blowing agents,
(f) chain-extenders and/or crosslinking agents and
(g) auxiliaries and/or additives
to afford a reaction mixture and reacting the reaction mixture to afford polyurethane, wherein
W— represents a cyclic amine which may be substituted and which is bonded to -Kw- via a nitrogen atom,
-Kw- represents a linear or branched-chain hydrocarbon radical,
N represents a nitrogen atom, C represents a carbon atom, O represents an oxygen atom and H represents a hydrogen atom and
-Q represents cyanide (—CN) or an electronegative radical of general formula —C(O)—R² and —R² represents a radical selected from the group consisting of —NH₂, —NH—R³ —NR⁴R⁵, —OR⁶ and —R⁷, wherein —R³, —R⁴, —R⁵, —R⁶ and —R⁷ are independently selected from the group consisting of aliphatic, araliphatic or aromatic hydrocarbons which may be substituted.

2. The process according to claim 1, wherein W represents a pyrrolidine ring which may be substituted.

3. The process according to claim 1, wherein -Kw-represents a linear, unsubstituted hydrocarbon radical having 1 to 10 carbon atoms.

4. The process according to claim 1, wherein Q represents —C(O)—NH-Kw-W, wherein -Kw- and —W are as defined in claim 1.

5. The process according to claim 4, wherein W represents a pyrrolidine ring which may be substituted, Kw- represents a linear, unsubstituted hydrocarbon radical having 1 to 10 carbon atoms and W and Kw are each identical.

6. The process according to claim 1, wherein the polymeric compounds having isocyanate-reactive groups (b) comprise polyetherols.

7. The process according to claim 1, wherein the catalysts (c) comprise incorporable amine catalysts, wherein incorporable amine catalysts comprise at least one isocyanate-reactive group.

8. The process according to claim 7, wherein the incorporable catalysts employed are compounds which, in addition to the isocyanate-reactive groups, comprise one or more tertiary, aliphatic amino groups.

9. The process according to claim 8, wherein at least one tertiary amino group of the incorporable catalyst bears two radicals independently of one another selected from the group consisting of methyl, ethyl, and also a further organic radical.

10. The process according to claim 1, wherein the polyurethane is a polyurethane foam having an average density of 10 to 850 g/L.

11. The process according to claim 1, wherein the polyurethane is a compact polyurethane having an average density of more than 850 g/L.

12. The process according to claim 1, wherein the polyurethane is a mattress or part of an item of furniture.

13. A polyurethane producible by a process according to claim 1.

14. A method of using the polyurethanes according to claim 13, the method comprising using the polyurethanes in an enclosed space.

15. The method according to claim 14, wherein the enclosed space is the interior of means of transport.
